(19) United States
(12) Patent Application Publication
(10) Pub. No.: US 2019/0375933 A1
(43) Pub. Date: Dec. 12, 2019

(54) POLY(BUTYLENE TEREPHTHALATE) COMPOSITION FOR ARTICLES HAVING HIGH DIMENSIONAL STABILITY

(71) Applicant: SABIC GLOBAL TECHNOLOGIES B.V., BERGEN OP ZOOM (NL)

(72) Inventor: Sjoerd Van Nispen, Geleen (NL)

(21) Appl. No.: 16/470,833

(22) PCT Filed: Dec. 21, 2017
(86) PCT No.: PCT/EP2017/084112

§ 371 Date: Jun. 18, 2019

(30) Foreign Application Priority Data
Dec. 21, 2016 (EP) 16205668.3

(51) Int. Cl. C08L 67/02; C08K 3/34; C08K 5/098; C08K 5/521; C08K 5/00; B29C 45/00

(52) U.S. Cl. CPC C08L 67/02; C08K 3/34; C08K 5/098; B29C 2045/0094; C08K 5/0083; B29C 45/0001; C08K 5/521

(57) ABSTRACT

The present invention relates to a polymer composition comprising poly(butylene terephthalate) and one or more nucleating agent. Such polymer composition allows for the production of small parts at a high cooling rate in injection moulding whilst still at a high degree of dimensional stability.

The present invention relates to a poly(butylene terephthalate) composition. The invention further relates to an article produced using such composition. The invention also relates to a method for production of such article.

Poly(butylene terephthalates) are well known and appreciated thermoplastic polymer materials that find their use in a wide variety of applications. One particular application relates to the use of poly(butylene terephthalates) for the production of shaped articles via shaping processes such as injection moulding. Injection moulded articles produced using poly(butylene terephthalate) have an array of properties that render them particularly suitable for many purposes.

A particular property of poly(butylene terephthalate) that renders it suitable for the production of articles via injection moulding is its chemical inertness. A further advantageous property of poly(butylene terephthalate) is its dimensional stability. This balance of material properties allows articles produced from poly(butylene terephthalate) to be suitable for amongst others use in certain devices such as in components for electronic applications and in medical devices.

A particular aspect of certain of the listed applications is that some of the parts that are used in such applications are very small, whilst still requiring a high degree of dimensional stability. Dimensional stability in this context may be understood as the ability to produce parts having defined dimensions with high accuracy in mass production processes such as injection moulding where the fraction of the moulded parts that do not possess the desired dimensions is low. A high dimensional stability indicates that a desired large fraction of the produced parts have dimensions within the desired tolerance ranges.

In the production of relatively small parts, such as parts having a material volume of ≤1 ml via injection moulding, the dimensional stability becomes a critical factor in the qualification of the moulded parts. In injection moulding, the shaping material is converted to a melt by introduction of energy in the form of shear and heat. The molten material is forced into a mould having the desired shape by exerting a pressure onto the molten material. In the moulding process, the molten material is forced into the mould via melt channels. Upon filling the mould with molten material, the mould is subjected to cooling wherein the material solidifies. As a result of this solidification and further cooling, the density of the material tends to change. Typically, where the material that is used in the injection moulding process is a poly(butylene terephthalate), the density increases as the material temperature is reduced.

In particular in the production of such small parts as presented above, the density increase during the solidification and cooling may differ from one part to the next in such way as to result in an undesirable variation of parts within a series. In the production of such small parts, homogeneous nucleation tends to occur with a high nucleation density, which may lead to blockage of the mould before the mould is completely filled with material. This leads to rejection of parts based on dimensional inaccuracies, thus demonstrating a too low dimensional stability.

Accordingly, there is a desire to be able to produce small poly(butylene terephthalate) parts via injection moulding having a high degree of dimensional stability.

This has now been achieved according to the present invention by a polymer composition comprising poly(butylene terephthalate) and one or more nucleating agent.

Such polymer composition allows for the production of parts having a material volume of ≤1 ml at a high degree of dimensional stability. A further advantage of such polymer composition is that is allows for the production of parts via injection moulding at cooling rates of ≥100 K/s or even ≥200 K/s at a high degree of dimensional stability.

A further advantage is that the polymer composition demonstrates such nucleation behaviour that during the injection moulding process, the molten polymer composition exhibits heterogeneous nucleation. This enables a more accurate filling of the mould.

In particular, the present invention relates to a polymer composition comprising poly(butylene terephthalate) and one or more nucleating agent such that the polymer composition exhibits heterogeneous nucleation when subjected to cooling at a cooling rate of ≥75° C./min, preferably ≥100° C./min, more preferably at a cooling rate of a 200° C./min.

In the context of the present invention, it may be understood that heterogeneous nucleation occurs when the cooling curve of the polymer composition as determined via differential scanning calorimetry (DSC) according to ISO 11357-1 (2016) provides a crystallisation temperature T_{p,c} above 190° C.

A particular embodiment of the invention relates to a polymer composition wherein the cooling curve of the polymer composition as determined via differential scanning calorimetry (DSC) according to ISO 11357-1 (2016), second cooling run, at a cooling rate of 90° C./min shows one or more crystallisation temperature T_{p,c} of ≥100° C., preferably ≥150° C., more preferably ≥175° C., even more preferably ≥190° C.

The poly(butylene terephthalate) as used in the polymer composition of the present invention may for example be a poly(butylene terephthalate) homopolymer, alternatively the poly(butylene terephthalate) may be a poly(butylene terephthalate) copolymer. Such poly(butylene terephthalate) homopolymer may consist of polymeric units derived from 1,4-butanediol and terephthalic acid or dimethyl terephthalate. Such poly(butylene terephthalate) copolymer may comprise polymeric units derived from 1,4-butanediol and terephthalic acid or dimethyl terephthalate. Such poly(butylene terephthalate) copolymer may further comprise a quantity of polymeric units derived from further monomers. Such further monomers may for example by dicarboxylic acids or esters thereof other than terephthalic acid or dimethyl terephthalate, such as for example isophthalic acid, or naphthalene dicarboxylic acid. Such further monomers may also in exemplary embodiments be diols other than 1,4-butanediol, such as for example ethanediol, 1,3-propanediol or cyclohexanedimethanol.

For example, the poly(butylene terephthalate) may comprise ≥90.0 wt %, preferably ≥95.0 wt %, more preferably ≥98.0 wt %, of polymeric units derived from 1,4-butanediol and terephthalic acid or dimethyl terephthalate, with regard to the total weight of the poly(butylene terephthalate).

For example, such poly(butylene terephthalate) copolymer may comprise ≤10.0 wt % of polymeric units derived from further monomers, preferably ≤5.0 wt %, such as ≥0.5 and ≤5.0 wt %, with regard to the total weight of the poly(butylene terephthalate).

In a particular embodiment, the poly(butylene terephthalate) copolymer comprises polymeric units derived from 1,4-butanediol and terephthalic acid or dimethyl terephthalate, and further ≥0.5 and ≤5.0 wt % polymeric units derived from isophthalic acid.

It is preferred that the poly(butylene terephthalate) has an intrinsic viscosity of a ≥0.50 and ≤2.00 dl/g, for example ≥0.70 and ≤1.00 dl/g, as determined in accordance with ASTM D2857-95 (2007).

In a further particular embodiment, the poly(butylene terephthalate) may comprise different poly(butylene terepthalates) having different product properties. For example, the poly(butylene terephthalate) may comprise a first poly(butylene terephthalate) and a second poly(butylene terephthalate). The poly(butylene terephthalate) may for example be a blend of such first poly(butylene terephthalate) and such second poly(butylene terephthalate). Such blend may be obtained by melt mixing of a mixture comprising the first poly(butylene terephthalate) and the second poly(butylene terephthalate). Alternatively, such blend may be obtained by mixing granules or powder particles of the first poly(butylene terephthalate) and the second poly(butylene terephthalate) in the solid state.

The first poly(butylene terephthalate) may for example have an intrinsic viscosity of 0.50-1.00 dl/g, alternatively 0.70-0.80 dl/g. The second poly(butylene terephthalate) may for example have an intrinsic viscosity of 1.00-1.50 dl/g, alternatively 1.15-1.40 dl/g. Preferably, the first poly(butylene terephthalate) has an intrinsic viscosity of 0.50-1.00 dl/g and the second poly(butylene terephthalate) has an intrinsic viscosity of 1.00-1.50 dl/g. More preferably, the first poly(butylene terephthalate) has an intrinsic viscosity of 0.70-0.80 dl/g and the second poly(butylene terephthalate) has an intrinsic viscosity of 1.15-1.40 dl/g.

The use of such blend of such first poly(butylene terephthalate) and such second poly(butylene terephthalate) allows for the preparation of blends having a desired intrinsic viscosity of the blend.

In a preferred embodiment of the invention, the poly(butylene terephthalate) comprises 50.0-90.0 wt % of the first poly(butylene terephthalate), with regard to the total weight of the poly(butylene terephthalate). More preferably, the poly(butylene terephthalate) comprises 70.0-85.0 wt % of the first poly(butylene terephthalate).

Further preferably, the poly(butylene terephthalate) comprises 10.0-50.0 wt % of the second poly(butylene terephthalate), with regard to the total weight of the poly(butylene terephthalate). More preferably, the poly(butylene terephthalate) comprises 15.0-30.0 wt % of the second poly(butylene terephthalate). In a particularly preferred embodiment, the poly(butylene terephthalate) comprises 70.0-85.0 wt % of the first poly(butylene terephthalate) and 15.0-30.0 wt % of the second poly(butylene terephthalate) with regard to the total weight of the poly(butylene terephthalate). For example, the poly(butylene terephthalate may comprise 70.0-85.0 wt % of a first poly(butylene terephthalate) having an intrinsic viscosity of 0.70-0.80 dl/g, and 15.0-30.0 wt % of a second poly(butylene terephthalate) having an intrinsic viscosity of 1.15-1.40 dl/g.

The polymer composition according to the present invention may for example comprise ≥90.0 wt % of poly(butylene terephthalate) with regard to the total weight of the polymer composition. More preferably, the polymer composition comprises ≥95.0 wt % of poly(butylene terephthalate), even more preferably ≥98.0 wt %. It is particularly preferable that the polymer composition comprises ≥99.0 wt % of poly(butylene terephthalate).

The polymer composition according to the present invention further comprises one or more nucleating agent.

Exemplary nucleating agents that may be used in the polymer composition according to the present invention include benzoic acid salts, substituted benzoic acid salts, bicyclic dicarboxylate metal salts, hexahydrophthalic acid metal salts, di-acetal derivatives such as sorbitol acetals, phosphate ester salts, glycerolate salts, di-, tri-, and tetra-amides, pine rosin derivatives, talc, kaolin, pigments, and combinations thereof.

In the embodiments of the present invention where the nucleating agent is talc, it is preferred that the talc has an average particle size of a ≥0.5 μm and ≤2.0 μm, even more preferably ≥0.8 μm and ≤1.5 μm. The average particle size may for example be determined as the particle size D₅₀ as determined in accordance with ISO 9276-2 (2014).

The nucleating agent may for example be selected from calcium, magnesium, aluminium, zinc, sodium or potassium salts of organic acids comprising 10-30 carbon atoms. For example, the nucleating agent may be selected from calcium, magnesium, aluminium, zinc, sodium or potassium salts of aliphatic organic acids comprising 10-30 carbon atoms.

Such calcium, magnesium, aluminium, zinc, sodium or potassium salts of organic acids comprising 10-30 carbon atoms may for example be selected from calcium laurate, magnesium laurate, aluminium laurate, zinc laurate, sodium laurate, potassium laurate, calcium myristate, magnesium myristate, aluminium myristate, zinc myristate, sodium myristate, potassium myristate, calcium palmitate, magnesium palmitate, aluminium palmitate, zinc palmitate, sodium palmitate, potassium palmitate, stearic acid, calcium stearate, magnesium stearate, aluminium stearate, zinc stearate, sodium stearate, potassium stearate, calcium oleate, magnesium oleate, aluminium oleate, zinc oleate, sodium oleate, potassium oleate, calcium arachidate, magnesium arachidate, zinc arachidate, aluminium arachidate, sodium arachidate, potassium arachidate, calcium behenate, magnesium behenate, zinc behenate, aluminium behenate, sodium behenate, potassium behenate, calcium lignocerate, magnesium lignocerate, zinc lignocerate, aluminium lignocerate, sodium lignocerate, potassium lignocerate, calcium cerotate, magnesium cerotate, zinc cerotate, aluminium cerotate, sodium cerotate, potassium cerotate, calcium montanate, magnesium montanate, zinc montanate, aluminium montanate, sodium montanate, potassium montanate, sodium acetate, sodium benzoate, aluminium benzoate, lithium benzoate, aluminium p-tert-butyl-benzoate, sodium rosinate, sodium abietate, calcium-1,2-cyclohexanedicarboxylate, bis(4-t-butylbenzene)aluminium salt, bicycle(2,2,1)heptane-2,3-dicarboxylic acid disodium salt, or combinations thereof.

The nucleating agent may for example be a phosphate salt. For example, the nucleating agent may be a phosphate salt of aluminium, lithium, calcium, sodium, zinc or potassium. Suitable phosphate salts that may be used as nucleating agents according to the present invention include for example trisodium phosphate, sodium 2,2′-methylenebis(4,6-di-tert-butylphenyl) phosphate, magnesium 2,2′-methylenebis(4,6-di-tert-butylphenyl) phosphate, aluminium 2,2′-methylenebis(4,6-di-tert-butylphenyl) phosphate, potassium 2,2′-methylenebis(4,6-di-tert-butylphenyl) phosphate, calcium 2,2′-methylenebis(4,6-di-tert-butylphenyl) phosphate, zinc 2,2′-methylenebis(4,6-di-tert-butylphenyl) phosphate, 2,2′-methylenebis(4,6-di-tert-butylphenyl) phosphate, lithium 2,2′-methylenebis(4,6-di-tert-butylphenyl) phosphate, aluminium methylenebis(2,4-di-tert-butyl-benzyloxy)phosphate, 2,2′-methylenebis(4,6-t-butylphenyl)phosphate sodium salt, and sodium bis(p-t-butylphenyl)phosphate.

Alternatively, the nucleating agent may for example be a compound comprising one or more sorbitol moiety. Exemplary compounds comprising one or more sorbitol moieties that may be used as nucleating agent in the polymer composition according to the present invention include dibenzylidenesorbitol, (4-methylbenzylidene)sorbitol, di-p-methylbenzylidenesorbitol, 1,3:2,4-di(p-chlorobenzylidene)sorbitol, bis(3,4-dimethylbenzylidene) sorbitol, bis(4-propylbenzylidene) propyl sorbitol, bis(4-ethylbenzylidene)sorbitol,

Further suitable nucleating agents that may be used as nucleating agent in the polymer composition according to the present invention include organic amides. Preferably, such organic amides comprise 5 to 40 carbon atoms, more preferably 10 to 40 carbon atoms. Such organic amides may be comprise one or more amide moieties, such as one amide moiety or two amide moieties. Preferably, such organic amides comprise 10 to 40 carbon atoms and two amide moieties. Further preferably, such organic amides comprise one or more aromatic moiety. It is particularly preferred that such organic amides comprise 10 to 40 carbon atoms, two amide moieties and one or more aromatic moiety.

For example, such organic amide may be a compound according to formula I:

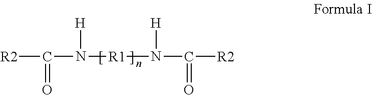

wherein:

R1 is a moiety comprising 1-20 carbon atoms, preferably 1-10 carbon atoms; R1 may me an aromatic or aliphatic moiety; n is 0 or 1; each R2 may be the same or different; each R2 is a moiety comprising 5-20 carbon atoms, preferably 5-15 carbon atoms. R2 may be an aliphatic moiety or may comprise one or more aromatic moieties.

Exemplary organic amides that may be used as nucleating agents in the polymer composition according to the present invention include N,N′-dicyclohexyl-2,6-naphthalene dicarboxylamide, N′-benzoylbenzohydrazide, N,N′-ethylenebis(stearamide), behenamide, 1,3,5-benzenetriscarboxamide, N-hexyl-N′-(2-hexylamino)-2-oxoethyl)oxamide and N,N′-ethylenebis(12-hydroxystearamide).

Other compounds that may be used as nucleating agent in the polymer composition according to the present invention include salts based on triglyceride oils, (3-(octylcarbamoyloxy)-2,2′-bis(octylcarbamoyloxymethyl)propyl)-N-octyl-carbamate, calcium hydroxide, calcium carbonate, carbon black, quinacridone, silica, zinc glycolate, 1,3,5-tris(2,2-dimethylpropionylamino)benzene, 4-biphenyl carboxylic acid, and thymine.

Alternatively, the one or more nucleating agent may be selected from ionomers such as ethylene-methacrylic acid copolymers.

For example, the nucleating agent may be one or more selected from talc, zinc stearate, sodium stearate, sodium acetate, sodium montanate, calcium 1R,2S-cyclohexanedicarboxylate, 2,2-methylenebis(4,6-di-tert-butylphenyl) phosphate aluminium hydroxide salt, endo-norbomane-2,3-dicarboxylic acid disodium salt, or combinations thereof.

The polymer composition according to the present invention preferably comprises ≥0.01 and ≤2.00 wt % of the one or more nucleating agent with regard to the total weight of the polymer composition. Preferably, the polymer composition comprises ≥0.05 and ≤0.50 wt % of the one or more nucleating agent with regard to the total weight of the polymer composition. Even more preferably, the polymer composition comprises ≥0.05 and ≤0.30 wt % of the one or more nucleating agent with regard to the total weight of the polymer composition.

In the embodiment where the one or more nucleating agent is selected from ionomers, the polymer composition preferably comprises ≥0.50 and ≤2.00 wt % of said nucleating agent(s) with regard to the total polymer composition. More preferably, in the embodiment where the one or more nucleating agent is selected from ionomers, the polymer composition preferably comprises ≥0.80 and ≤1.50 wt % of said nucleating agent(s) with regard to the total polymer composition.

In a particular embodiment, the polymer composition according to the present invention comprises ≥0.01 and ≤2.00 wt % of the one or more nucleating agent with regard to the total weight of the polymer composition, more preferably ≥0.01 and ≤0.50 wt %, even more preferably ≥0.01 and ≤0.30 wt %, or ≥0.01 and ≤0.10 wt %, or ≥0.01 and ≤0.05 wt %, wherein the nucleating agent is one or more selected from talc, zinc stearate, sodium stearate, sodium acetate, sodium montanate, calcium 1R,2S-cyclohexanedicarboxylate, 2,2-methylenebis(4,6-di-tert-butylphenyl) phosphate aluminium hydroxide salt, endo-norbomane-2,3-dicarboxylic acid disodium salt, or combinations thereof.

In particular, the present invention relates to a polymer composition comprising poly(butylene terephthalate) and a compound selected from benzoic acid salts, substituted benzoic acid salts, bicyclic dicarboxylate metal salts, hexahydrophthalic acid metal salts, sorbitol acetals, phosphate ester salts, glycerolate salts, di-, tri-, and tetra-amides, pine rosin derivatives, talc, kaolin, phosphate salts of aluminium, lithium, calcium, sodium, zinc or potassium, calcium, magnesium, aluminium, zinc, sodium or potassium salts of organic acids comprising 10-30 carbon atoms, compounds comprising one or more sorbitol moiety, organic amides comprising 5 to 40 carbon atoms, ethylene-methacrylic acid copolymers, and combinations thereof.

In an embodiment, the present invention relates to a polymer composition comprising poly(butylene terephthalate) and 0.01-0.30 wt % a compound selected from benzoic acid salts, substituted benzoic acid salts, bicyclic dicarboxylate metal salts, hexahydrophthalic acid metal salts, sorbitol acetals, phosphate ester salts, glycerolate salts, di-, tri-, and tetra-amides, pine rosin derivatives, talc, kaolin, phosphate salts of aluminium, lithium, calcium, sodium, zinc or potassium, calcium, magnesium, aluminium, zinc, sodium or potassium salts of organic acids comprising 10-30 carbon atoms, compounds comprising one or more sorbitol moiety, organic amides comprising 5 to 40 carbon atoms, ethylene-methacrylic acid copolymers, and combinations thereof, with regard to the total weight of the polymer composition.

In a further embodiment, the present invention relates to a polymer composition comprising poly(butylene terephthalate) and 0.01-0.30 wt % a compound selected from benzoic acid salts, substituted benzoic acid salts, bicyclic dicarboxylate metal salts, hexahydrophthalic acid metal salts, sorbitol acetals, phosphate ester salts, glycerolate salts, di-, tri-, and tetra-amides, pine rosin derivatives, talc, kaolin, phosphate salts of aluminium, lithium, calcium, sodium, zinc or potassium, calcium, magnesium, aluminium, zinc, sodium or potassium salts of organic acids comprising 10-30 carbon atoms, compounds comprising one or more sorbitol moiety, organic amides comprising 5 to 40 carbon atoms, ethylene-methacrylic acid copolymers, and combinations thereof, with regard to the total weight of the polymer composition.

In a particular embodiment, the polymer composition according to the present invention consists of poly(butylene terephthalate) and 0.01-0.30 wt % a compound selected from benzoic acid salts, substituted benzoic acid salts, bicyclic dicarboxylate metal salts, hexahydrophthalic acid metal salts, sorbitol acetals, phosphate ester salts, glycerolate salts, di-, tri-, and tetra-amides, pine rosin derivatives, talc, kaolin, phosphate salts of aluminium, lithium, calcium, sodium, zinc or potassium, calcium, magnesium, aluminium, zinc, sodium or potassium salts of organic acids comprising 10-30 carbon atoms, compounds comprising one or more sorbitol moiety, organic amides comprising 5 to 40 carbon atoms, ethylene-methacrylic acid copolymers, and combinations thereof, with regard to the total weight of the polymer composition.

In a further particular embodiment, the polymer composition according to the present invention consists of poly(butylene terephthalate) and 0.01-0.30 wt %, or 0.01-0.10 wt %, or 0.01-0.05 wt %, of a compound selected from talc, zinc stearate, sodium stearate, sodium acetate, sodium montanate, calcium 1R,2S-cyclohexanedicarboxylate, 2,2-methylenebis(4,6-di-tert-butylphenyl) phosphate aluminium hydroxide salt, endo-norbornane-2,3-dicarboxylic acid disodium salt, or combinations thereof, with regard to the total weight of the polymer composition.

The use of such nucleating agent is understood to result in a reliable crystallisation behaviour of the poly(butylene terephthalate) during the solidification and cooling upon shaping by injection moulding. In the production of small injection moulded parts, this is understood to result in a reduction of parts having a change in dimensions during solidification and cooling outside the tolerance ranges. Furthermore, polymer compositions according to the present invention are understood to demonstrate an improved mould filling behaviour during injection moulding, which is understood to be caused by the occurrence of heterogeneous crystallisation, resulting in a reduction of undesired nucleation during the moulding process and an improved dimensional stability of the shaped parts. In particular, this allows for the production of parts having a thin wall thickness because of this improved mould filling behaviour.

In one of its embodiments, the present invention also relates to a process for the production of the polymer composition via melt compounding in a melt extruder. It also relates to a process for the production of a shaped article by an injection moulding process. In particular, in such injection moulding process, the polymer composition may be introduced into a mould in the molten state and cooled to below the melt temperature to obtain a shaped article. In a particular embodiment, such injection moulding process is arranged to produce shaped articles having a volume of ≤1.0 ml.

The invention also relates to a shaped article having a volume of ≤1.0 ml produced using the polymer composition according to the invention.

In a further particular embodiment, the present invention relates to a polymer composition comprising:
≥98.0 wt % of a poly(butylene terephthalate) having an intrinsic viscosity of ≥0.70 and ≤1.00 dl/g, as determined in accordance with ASTM D2857-95 (2007); and
≥0.01 and ≤0.50 wt % of a nucleating agent wherein the nucleating agent is talc, wherein the talc has an average particle size preferably ≥0.8 μm and ≤1.5 μm, wherein the average particle size is determined as the particle size D₅₀ as determined in accordance with ISO 9276-2 (2014).

In a further more particular embodiment, the present invention relates to a polymer composition comprising:
≥98.0 wt % of a poly(butylene terephthalate) having an intrinsic viscosity of ≥0.70 and ≤1.00 dl/g, as determined in accordance with ASTM D2857-95 (2007); and
≥0.01 and ≤0.10 wt % of a nucleating agent wherein the nucleating agent is talc, wherein the talc has an average particle size preferably ≥0.8 μm and ≤1.5 μm, wherein the average particle size is determined as the particle size D₅₀ as determined in accordance with ISO 9276-2 (2014).

In a further even more particular embodiment, the present invention relates to a polymer composition comprising:
≥98.0 wt % of a poly(butylene terephthalate) having an intrinsic viscosity of ≥0.70 and ≤1.00 dl/g, as determined in accordance with ASTM D2857-95 (2007); and
≥0.01 and ≤0.05 wt % of a nucleating agent wherein the nucleating agent is talc, wherein the talc has an average particle size preferably ≥0.8 μm and ≤1.5 μm, wherein the average particle size is determined as the particle size D₅₀ as determined in accordance with ISO 9276-2 (2014).

The invention will now be illustrated by the following non-limiting examples.

In a 25 mm twin screw extruder, polymer compositions were prepared via melt extrusion at a temperature of 260° C. and an extruder screw speed of 200 rpm with subsequent cooling and granulation, using the following extruder settings:

| | | | | | Screw | Through- | | |
|---|---|---|---|---|---|---|---|---|
| Zone temperature (° C.) | | | | | speed | put | Torque | Vac- |
| 1 | 2 | 4 | 5 | 6 | (rpm) | (kg/h) | (%) | uum |
| 150 | 260 | 260 | 250 | 260 | 200 | 24.8 | 65 | yes |

Compounds were prepared according to the formulations as presented in table I:

TABLE I
material formulations (parts by weight)

| Example | 1(C) | 2 | 3 | 4 | 5 | 6 | 7 | 8 |
|---|---|---|---|---|---|---|---|---|
| PBT195 | 73.64 | 73.635 | 73.63 | 73.615 | 73.59 | 73.54 | 73.44 | 73.14 |
| PBT315 | 26.0 | 26.0 | 26.0 | 26.0 | 26.0 | 26.0 | 26.0 | 26.0 |
| Jetfine | 0 | 0.005 | 0.01 | 0.025 | 0.05 | 0.10 | 0.20 | 0.50 |
| 3CA | | | | | | | | |
| AO1010 | 0.06 | 0.06 | 0.06 | 0.06 | 0.06 | 0.06 | 0.06 | 0.06 |
| PETS | 0.30 | 0.30 | 0.30 | 0.30 | 0.30 | 0.30 | 0.30 | 0.30 |

| Example | 9 | 10 | 11 | 12 | 13 | 14 | 15 | 16 |
|---|---|---|---|---|---|---|---|---|
| PBT195 | 73.44 | 73.54 | 73.54 | 73.54 | | 73.59 | 73.565 | 73.54 |
| PBT315 | 26.0 | 26.0 | 26.0 | 26.0 | 26.0 | 26.0 | 26.0 | 26.0 |
| AO1010 | 0.06 | 0.06 | 0.06 | 0.06 | 0.06 | 0.06 | 0.06 | 0.06 |
| PETS | 0.30 | 0.30 | 0.30 | 0.30 | 0.30 | 0.30 | 0.30 | 0.30 |
| HPN20E | | 0.10 | | | | | | |
| HPN68 | | | 0.10 | | | | | |
| NA21 | 0.20 | | | | | 0.05 | 0.075 | 0.10 |
| NaS | | | | 0.10 | | | | |
| NaV | | | | | 0.35 | | | |

| Example | 17 | 18 | 19 | 20 | 21 | 22 | 23 | 24 | 25 | 26 |
|---|---|---|---|---|---|---|---|---|---|---|
| PBT195 | 73.515 | 73.59 | 73.565 | 73.515 | 73.59 | 73.565 | 73.515 | 73.59 | 73.565 | 73.515 |
| PBT315 | 26.0 | 26.0 | 26.0 | 26.0 | 26.0 | 26.0 | 26.0 | 26.0 | 26.0 | 26.0 |
| AO1010 | 0.06 | 0.06 | 0.06 | 0.06 | 0.06 | 0.06 | 0.06 | 0.06 | 0.06 | 0.06 |
| PETS | 0.30 | 0.30 | 0.30 | 0.30 | 0.30 | 0.30 | 0.30 | 0.30 | 0.30 | 0.30 |
| HPN20E | | 0.05 | 0.075 | 0.125 | | | | | | |
| HPN68 | | | | | 0.05 | 0.075 | 0.125 | | | |
| NA21 | 0.125 | | | | | | | | | |
| NaS | | | | | | | | 0.05 | 0.075 | 0.125 |
| NaV | | | | | | | | | | |

Wherein:

| | |
|---|---|
| PBT315 | Poly(butylene terephthalate) having an intrinsic |
| | viscosity of 1.10 dl/g, grade Valox 315, obtainable |
| | from SABIC |
| PBT195 | Poly(butylene terephthalate) having an intrinsic |
| | viscosity of 0.66 dl/g, grade Valox 195, obtainable |
| | from SABIC |
| Jetfine 3CA | Talc, having average particle size D₅₀ of 1.0 μm |
| | obtainable from Imerys |
| PETS | Pentaerythritol tetrastearate, CAS reg. no. 115-83-3, |
| | obtainable from FACI |
| AO1010 | Pentaerythritol, tetrakis(3,5-di-tert-butyl-4- |
| | hydroxyhydrocinnamate), CAS reg. no. 6683-19-8, |
| | obtainable from BASF |
| HPN20E | Blend of 66 wt % of zinc stearate, CAS reg. no. 557-05-1, |
| | and 34 wt % of calcium 1R,2S-cyclohexanedicarboxylate, |
| | CAS reg. no. 491589-22-1, obtainable from Milliken as |
| | Hyperform HPN-20E |
| HPN68 | Endo-norbornane-2,3-dicarboxylic acid disodium salt, CAS |
| | reg. no. 23838-83-7, obtainable from Milliken as |
| | Hyperform HPN-68 |
| NA21 | 2,2-methylenebis(4,6-di-tert-butylphenyl) phosphate |
| | aluminium hydroxide salt, CAS reg. no. 151841-65-5, |
| | obtainable from Adeka as ADK Stab NA-21 |
| NaS | Sodium stearate, CAS reg. no. 822-16-2 |
| NaV | Sodium montanate, CAS reg. no. 25728-82-9, obtainable |
| | from Clariant as Licomont NaV101 |

Example 1 without nucleating agent was included for comparative purposes.

Material properties were determined on the polymer compositions of examples 1-8 as obtained according to the preparation above. The results are presented in table II below.

TABLE II
Material properties.

| Example | 1(C) | 2 | 3 | 4 | 5 | 6 | 7 | 8 | 10 | 16 |
|---|---|---|---|---|---|---|---|---|---|---|
| MVR 1.2 kg | 31 | 31 | 32 | 32 | 32 | 34 | 34 | 33 | 30 | 40 |
| MVR 2.16 kg | 64 | 64 | 63 | 63 | 64 | 63 | 61 | 59 | | |
| Charpy unnotched −30° C. | 107 | 118 | 114 | | 114 | 103 | 96 | 89 | | |
| T_{p, c} at −200° C./min | 173 | 184 | 186 | 180 | 187 | 178 | 184 | 182 | | |
| T_{p, c} at −20° C./min | 191 | 196 | 198 | 198 | 198 | 198 | 200 | 200 | | |
| T_{p, c} at −2° C./min | 202 | 206 | 207 | 207 | 208 | 208 | 209 | 209 | | |

| Example | 1(C) | 7 | 10 | 16 |
|---|---|---|---|---|
| MV@100/s | 133 | 127 | 128 | 91 |
| MV@200/s | 109 | 108 | 108 | 75 |
| MV@500/s | 96 | 98 | 98 | 69 |
| MV@1000/s | 88 | 89 | 89 | 65 |
| MV@1500/s | 81 | 82 | 81 | 61 |
| MV@5000/s | 57 | 57 | 56 | 46 |
| Eₜ | 2575 | 2777 | 2686 | 2700 |
| σ_{y} | 57 | 63 | 61 | 63 |
| σ_{b} | 38 | 58 | 57 | 58 |
| E_{f} | 2443 | 2609 | 2476 | 2485 |
| σ_{fM} | 83 | 86 | 84 | 85 |
| MAI | 36 | 41 | 46 | 29 |

Wherein:
MVR 1.2 kg is the melt volume flow rate determined at 250° C. under a load of 1.2 kg in accordance with ISO 1133-1 (2011), expressed in cm³/10 min.
MVR 2.16 kg is the melt volume flow rate determined at 250° C. under a load of 2.16 kg in accordance with ISO 1133-1 (2011), expressed in cm³/10 min.
Charpy unnotched −30° C. is the unnotched Charpy impact strength determined on samples at −30° C. according to ISO 179 (2000), expressed in kg/m².
Eₜ is the modulus, expressed in MPa, determined in accordance with ISO 527-1 (2012).
σ_{y} is the stress at yield, expressed in MPa, determined in accordance with ISO 527-1 (2012).
σ_{b} is the stress at break, expressed in MPa, determined in accordance with ISO 527-1 (2012).
σ_{fM} is the flexural strength, expressed in MPa, determined in accordance with ISO 178 (2010), at room temperature (23° C.).
E_{f} is the flexural modulus, expressed in MPa, determined in accordance with ISO 178 (2010), at room temperature (23° C.).
VST is the Vicat softening temperature, determined in accordance with ISO 306 (2013), expressed in ° C., measured at 50N force and a heating rate of 120° C./hr (=method B120).
HDT is the temperature of deflection under load, also referred to as heat distortion temperature, determined in accordance with ISO 75-2 (2013), flatwise, using 0.45 MPa (=method B) and 1.8 MPa load (=method A).
MAI is the multi-axial impact strength, expressed in joule, determined as the puncture energy in accordance with ISO 6603-2 (2000) at an impact velocity of 4.4 m/s at room temperature (23° C.).
T_{p,c} at −90° C./min, at −20° C./min and at −2° C./min are the peak crystallisation temperatures in ° C. as determined via DSC second cooling run according to ISO 11357-1 (2016).
MV is the melt viscosity, expressed in Pa·s, as determined in accordance with ISO 11443 (2014) at 240° C., at multiple shear rates, e.g. MV@100/s indicates the MV at a shear rate of 100 s⁻¹.

For determination of the dimensional stability, a number of the sample material compounded as described above were moulded into tensile bars having dimensions according to the definition of ISO 527-1, as well as into plaques having a thickness of 3.0 mm, a width of 60 mm and a length of 60 mm, where the material was injected into the mould in the lengthwise direction. Injection moulding was done using an Engel injection moulding machine using pre-dried material with a pre-dry temperature of 120° C., pre-dry time of 2 hours, a hopper temperature of 40° C., injection moulding zone temperatures of 210° C. in zone 1, 250° C. in zone 2, 260° C. in zone 3, 255° C. at the injection nozzle, and 70° C. as mould temperature, using a cycle time of 35 s.

The dimensional stability was determined by measuring the length of the tensile bar as A-direction, the length of the plaque as the B-direction, and the width of the plaque as the C-direction. The mold shrinkage, used as indicator for the dimensional stability, in each of the directions were determined by calculating the difference in % between the dimension of the mould and the dimension of the moulded part. The obtained results are presented in the table herein below.

Mold Shrinkage Results

| | Example | | | | | | | | | | | |
|---|---|---|---|---|---|---|---|---|---|---|---|---|
| Direction | 1 | 7 | 9 | 10 | 11 | 12 | 13 | 14 | 15 | 16 | 17 | 18 |
| A | 1.92 | 2.27 | 2.13 | 2.08 | 2.03 | 2.15 | 2.23 | | | | | |
| B | 2.05 | 2.52 | 2.22 | 2.23 | 2.25 | 2.30 | 2.72 | 2.02 | 2.36 | 2.33 | 2.44 | 2.21 |
| C | 1.83 | 2.24 | 2.18 | 2.14 | 2.18 | 2.00 | 2.26 | 1.85 | 2.17 | 2.16 | 2.22 | 2.03 |

Example

| Direction | 19 | 20 | 21 | 22 | 23 | 24 | 25 | 26 |
|---|---|---|---|---|---|---|---|---|
| A | | | | | | | | |
| B | 2.34 | 2.47 | 2.38 | 2.38 | 2.62 | 2.04 | 2.08 | 2.23 |
| C | 2.12 | 2.28 | 2.20 | 2.15 | 2.40 | 1.92 | 1.93 | 1.98 |

Further, the non-isothermal crystallisation temperatures (T_{c}) in ° C. of some of the materials was determined via DSC using a Discovery DSC equipped with liquid nitrogen cooling (TA Instruments) by performing heat/cool/heat experiments with different cooling rates. The samples were heated to 260° C. at a heating rate of 20° C./min, and cooled to 0° C. with a cooling rate of 90° C./min, 20° C./min and 2° C./min, and heated for the second time to 260° C. A constant nitrogen flow of 50 ml/min was used, and the pan type was Tzero crimped pan. Results are presented in the table below.

| Example | 1 | 7 | 12 | 16 | 19 | 22 |
|---|---|---|---|---|---|---|
| T_{c} @ −2° C./min | 202 | 209 | 206 | 211 | 212 | 201 |
| T_{c} @ −20° C./min | 191 | 198 | 198 | 202 | 205 | 195 |
| T_{c} @ −90° C./min | 183 | 194 | 187 | 193 | 193 | 184 |

1. A polymer composition comprising:
poly(butylene terephthalate); and
a nucleating agent.

2. The polymer composition according to claim 1, wherein the cooling curve of the polymer composition as determined via differential scanning calorimetry (DSC) according to ISO 11357-1 (2016), second cooling run, at a cooling rate of 90° C./min shows a crystallisation temperature T_{p,c} of ≥190° C.

3. The polymer composition according to claim 1, wherein the nucleating agent is selected from benzoic acid salts, substituted benzoic acid salts, bicyclic dicarboxylate metal salts, hexahydrophthalic acid metal salts, sorbitol acetals, phosphate ester salts, glycerolate salts, di-, tri-, and tetra-amides, pine rosin derivatives, talc, kaolin, phosphate salts of aluminium, lithium, calcium, sodium, zinc or potassium, calcium, magnesium, aluminium, zinc, sodium or potassium salts of organic acids comprising 10-30 carbon atoms, compounds comprising a sorbitol moiety, organic amides comprising 5 to 40 carbon atoms, and combinations thereof.

4. The polymer composition according to claim 1, wherein the polymer composition comprises ≥95.0 wt % of the poly(butylene terephthalate) with regard to the total weight of the polymer composition.

5. The polymer composition according to claim 1, wherein the polymer composition comprises ≥98.0 wt % of the poly(butylene terephthalate) with regard to the total weight of the polymer composition.

6. The polymer composition according to claim 1, wherein the polymer composition comprises ≥0.01 and ≤2.00 wt % of the nucleating agent with regard to the total weight of the polymer composition.

7. The polymer composition according to claim 1, wherein the polymer composition comprises ≥0.01 and ≤0.50 wt % of the nucleating agent with regard to the total weight of the polymer composition.

8. The polymer composition according to claim 1, wherein the nucleating agent is selected from talc, zinc stearate, sodium stearate, sodium acetate, sodium montanate, calcium 1R,2S-cyclohexanedicarboxylate, 2,2-methylenebis(4,6-di-tert-butylphenyl) phosphate aluminium hydroxide salt, endo-norbornane-2,3-dicarboxylic acid disodium salt, or combinations thereof.

9. The polymer composition according to claim 1, wherein the poly(butylene terephthalate) has an intrinsic viscosity of ≥0.50 and ≤2.00 dl/g as determined in accordance with ASTM D2857-95 (2007).

10. The polymer composition according to claim 1, wherein the poly(butylene terephthalate) comprises ≥90.0 wt % of polymeric units derived from 1,4-butanediol and terephthalic acid or dimethyl terephthalate, with regard to the total weight of the poly(butylene terephthalate).

11. A process for the production of a polymer composition according to claim 1 via melt compounding in a melt extruder.

12. The process for the production of a shaped article by an injection moulding process using the polymer composition according to claim 1.

13. The process according to claim 12, in which the polymer composition is introduced into a mould in the molten state cooled to below the melt temperature to obtain a shaped article.

14. The process according to claim 12, wherein the shaped article has a volume of ≤1.0 ml.

15. A shaped article having a volume of ≤1.0 ml produced using the polymer composition according to claim 1.
